(19) United States
(12) Patent Application Publication
(10) Pub. No.: US 2005/0211099 A1
(43) Pub. Date: Sep. 29, 2005

(54) Spiral composite adsorbent material

(76) Inventors: David T. Doughty, Moon Twp, PA (US); John W. Cobes, Harmony, PA (US)

Correspondence Address: COHEN & GRIGSBY, P.C., 11 STANWIX STREET, 15TH FLOOR, PITTSBURGH, PA, 15222, US

(21) Appl. No.: 10/807,375

(22) Filed: Mar. 23, 2004

(51) Int. Cl. B01D 53/02

(52) U.S. Cl. 96/108

(57) ABSTRACT

A composite adsorbent includes a shaped substrate having an adhesive film on a portion of at least one side and an adsorbent that has been immobilized as a layer on the adhesive portion of the substrate. The composite adsorbent is designed to be shaped into a form that provides a high adsorption capacity, low pressure drop, high volume capacity, and fast adsorption kinetics to effectively adsorb odors over an extended period of time. Optionally, the composite adsorbent is also used in combination with an air permeable unit wherein it is advantageously positioned to provide enhanced adsorption of contaminants found in gas phase.

### FIELD OF INVENTION

This invention relates to a composite for the treatment or adsorption of gases and, more particularly, to a shaped composite adsorbent or device containing a shaped composite adsorbent.

### BACKGROUND OF THE INVENTION

Devices containing adsorbent materials for removing vapor phase contaminants from gas phase streams are known. Such devices may remove odors or purify ambient air. Some are used to remove contaminants from commercial and industrial gases. Typically these devices include an adsorbent material such as calcium phosphate, sodium bicarbonate powder, baking soda, or charcoal or carbon particles, wherein the adsorbent is provided as a bed of packed particles or pillow of bulk carbon. Such an arrangement, however, decreases the accessibility of the adsorbent to the gas streams or odiferous substances to be treated. A significant amount of adsorbent may be required to provide effective absorption. This can require a sizeable device to accommodate the adsorbent or a smaller sized one that is more frequently replaced. A smaller bed size limits exposure to absorbents thereby limiting their adsorption capacity and kinetics.

G.B. Pat. No. 1,476,761 discloses a composite using layers of activated carbon cloth (ACC) spaced apart with a granular activated carbon (GAC) particles that are bonded to the cloth to provide reduced pressure drop. Similarly, U.S. Pat. No. 4,234,326 employs ACC, but the spacer particles are an inert material with no adsorption capacity. In both cases, the ACC substrate is a cost prohibitive material. Another approach is to apply a slurry of the particulate material and adhesive to a substrate. In this case, the adhesive decreases the capacity of an active particulate material by coating it. U.S. Pat. No. 4,604,110 recognizes a problem of increased pressure drop as the thickness of a layer of adsorbent material increases. Although it notes the advantages of minimizing the pressure drop, the inventor does not recognize a shaped composite solution to the problem. U.S. Pat. No. 5,120,331 describes a device that uses a permeable fibrous material or fabric embedded with activated carbon or some other functional particulate material that is wound about a center structure. However, without reliance on a porous substrate, this device could not function as described.

Sometimes more than one adsorbent is used and or additional components are added to the adsorbents including stearic acid, urea and/or fragrance. Such combinations may involve complex manufacturing techniques which become more costly. Use of fragrance may simply mask gases or odors rather than absorb them. U.S. Pat. Nos. 5,582,865, 5,779,847, and 6,024,813 describe processes whereby functional particulate materials are adhered to fibrous substrate materials using a dry bonding process. Again, these processes are made exclusively with fibrous materials. Further, they require multi-step processing and involve the forming of multiple mats, the use of specific blends of specific fibers, special manipulation to distribute the particulate throughout the mat, multiple heating stations, cooling, etc.

Thus, there is a need for an adsorbent composite which efficiently utilizes the adsorbent to effectively absorb odors and purify gas streams over an extended period of time, has high adsorption capacity, low pressure drop, high volume capacity, and fast adsorption kinetics, and that can be produced using standard or simplified manufacturing techniques. Despite the range of prior art describing prior adsorbent devices, it has not been previously recognized that the performance of an adsorbent composite can be dramatically enhanced by immobilizing a layer of adsorbent granules on an adhesive sided substrate shaped into a spiral or folded form.

### SUMMARY OF THE INVENTION

The present invention is directed to a composite adsorbent that includes a shaped substrate having an adhesive film on a portion of at least one side thereof, and an adsorbent that has been immobilized as a layer on the substrate adhesive portion. The composite uses a functional solid material that is capable of purifying a gas phase stream. The invention is also directed to a composite adsorbent in combination with an air permeable housing.

The present invention represents a substantial advance over prior composite adsorbents or devices. The present invention requires a substrate shaped into a spiral, disc, or cylinder, or otherwise folded over on itself. In this form, this novel composite has an advantage in that it improves access to the particulate material compared to a packed bed of material by providing a layer of particulate material along a substrate while also maintaining a high particulate density. Because only a minimal amount of the surface area of the particulate is necessary to secure it to the substrate, the capacity of the particulate remains close to that of bulk material particulate.

The current invention does not require the application of spray adhesives or the handling of powders to realize the advantages of maximizing the surface area of the particulate adsorbent material as required by traditional devices. Thus, dusting is also minimized by the immobilization of the particulate material. Unlike traditional devices, the invention uses a unique substrate comprised of a non-porous material. In an embodiment, the present invention has the further advantage that the adsorbent composite is used in a device having a form that is more practical to handle, more space efficient, and more attractive for a consumer product. Because of the unique construction of this composite, high adsorption capacity, fast adsorption kinetics, high volume capacity, low dusting, low pressure drop, and low cost can be realized.

The invention also has the advantage that it offers a non-toxic solution and contains no chemicals or fragrances. Odors are adsorbed by the current invention, and not just covered up. Another advantage of an embodiment of the present invention is that the composite and the deodorizing device can both be made with simple manufacturing processes and low cost, readily available materials such as adhesive tape and activated carbon. The device effectively treats gas streams and adsorbs odors over an extended period of time. Those and other features and advantages of the present invention will become apparent form the following description, drawings and claims.

### BRIEF DESCRIPTION OF THE DRAWINGS

The accompanying drawings illustrate examples of embodiments of the invention. In such drawings:

FIG. 1 shows a perspective view of an embodiment of the substrate partially coated with particulate.

FIG. 2 shows an embodiment of the shaped composite adsorbent.

FIG. 3 shows another embodiment of the shaped composite adsorbent.

FIG. 4 shows a side view of an embodiment of the shaped composite adsorbent.

FIG. 5 shows a cut-away pie section of an embodiment of the shaped composite adsorbent.

FIG. 6 shows an air permeable housing enclosing a shaped composite adsorbent in an embodiment of the present invention.

### DETAILED DESCRIPTION OF THE INVENTION

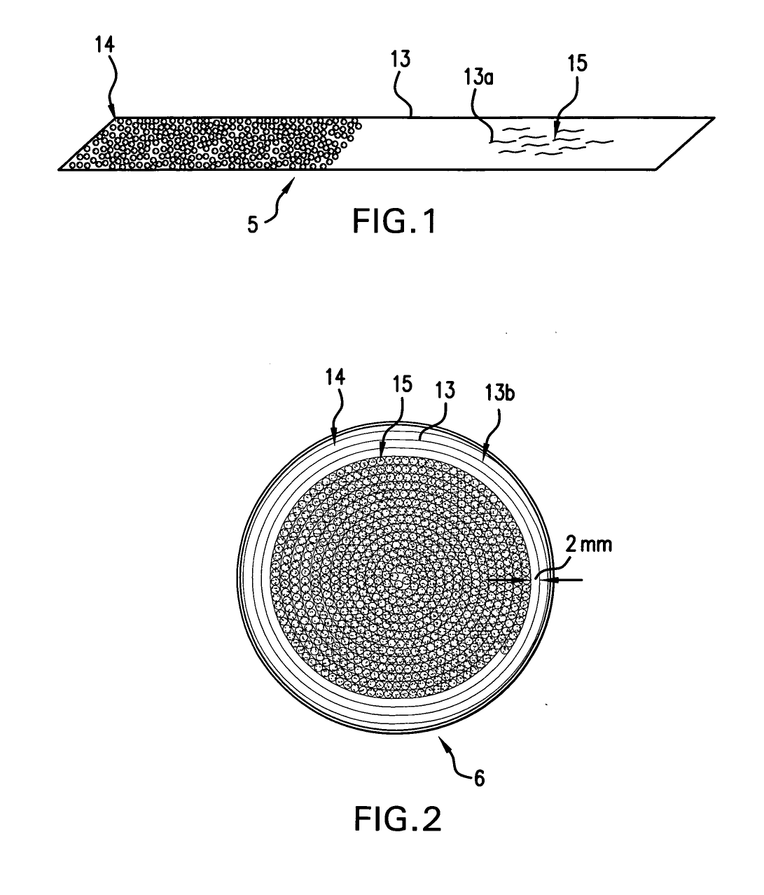

As shown in the drawings for purposes of illustration, the present invention comprises a novel composite adsorbent. As generally shown in FIG. 1, composite 5 comprises a substrate 13 capable of being formed or wound into a compressed shape, for example a coil or a spiral shape, to which a layer of adsorbent material 14, such as activated carbon, has been thinly applied.

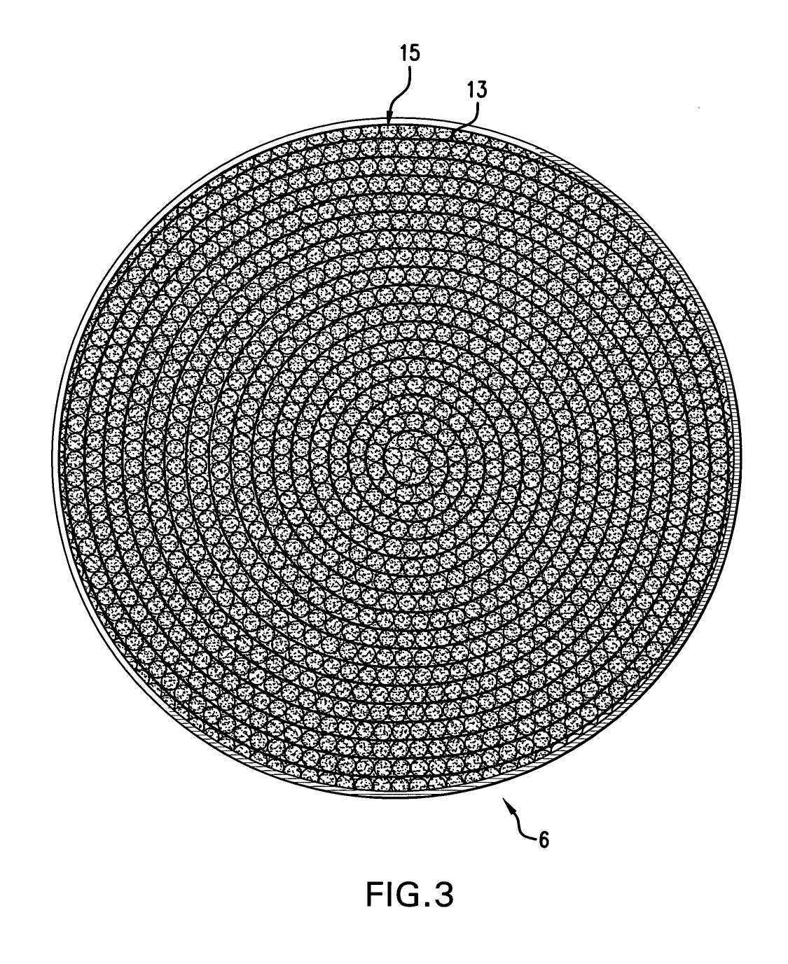

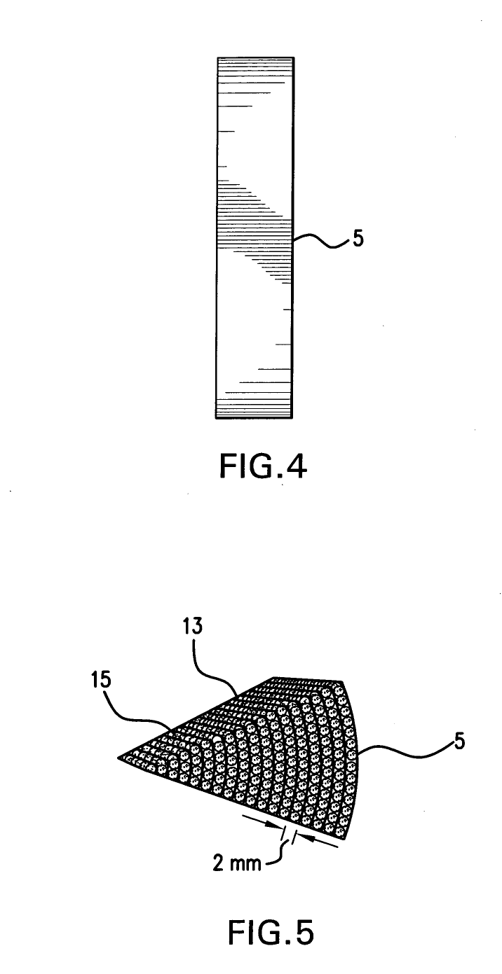

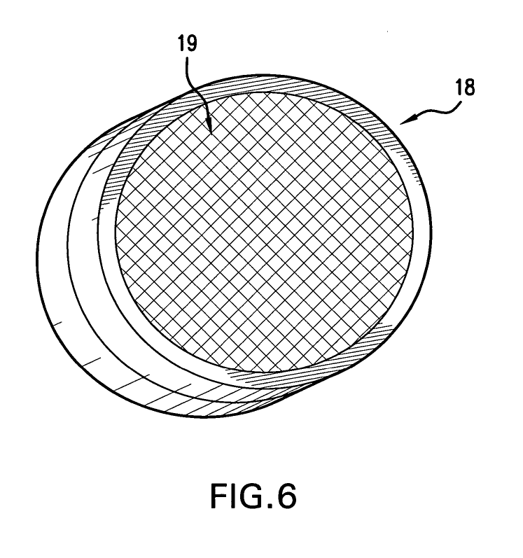

In an example, substrate 13 is material, fabric, cloth, or polymer film having at least one adhesive side 13a to which adhesive 15 is or has been provided. Adsorbent 14 is applied along substrate adhesive side 13a. Alternatively, adhesive 15 may be an integral art of substrate side 13a. In an example, adsorbent 14 is applied to produce a uniform distribution. Preferably, adsorbent 14 is applied as a mono-layer on adhsive 15. Composite 12 is then shaped so that the adhesive adsorbent coated side 13a touches a non-adhesive side 13b of substrate 13. Substrate 13 may be folded over once or multiple times, or wound into a coil or spiral form as shown, for example, in FIGS. 2-5. It may also be coiled to accommodate and fit within an enclosure 18 as shown for instance in FIG. 6. Enclosure 18 may optionally be used in combination with a filtration unit Adsorbent composite 5 is prepared by the application of the adsorbent material 14 to adhesive 15 of the adhesive side 13a of substrate 13. Suitable materials for substrate 13 include acrylics, polycarbonates, polyimides, polyphenylene ether, polyphenylene sulfide, acrylonitrile-butadiene-styrene copolymers (ABS), polyesters, ethylene vinyl acetate (EVA), polyurethanes, polyamides, polyolefins, blends and derivatives thereof. Suitable adhesives 15 include acrylics, vinyl ethers, natural or synthetic rubber-based materials, poly (alpha-olefins), and silicones. The substrate and adhesive are chosen in such a way as to minimize cost but also to meet the strength, temperature, humidity, and chemical resistance requirements of a given application. The flexibility characteristics of the substrate are important so that the composite can be used in the form of a spiral. It can also be used as a folded sheet, layers of sheets, a ribbon, roll, coil, etc. depending upon desired application. The substrate is sized and shaped to accommodate a particular application. For some applications it is shaped into a long cylindrical form having a small diameter for use, for example, inside a pipe or drum. With smaller applications it can be shaped into a disc-form having a generally skinny width and a larger diameter. For an example, a disc shaped substrate is used measuring about 100 to 150 linear inches having a width ranges from 0.25 inches to 1.0 inch wide.

Suitable adsorbent materials 14 include activated carbons, impregnated activated carbons, silicas, natural and man-made zeolites, molecular sieves, clays, aluminas, or ion exchange resins. Any granular or powdered material, regardless of particle size, can be applied to the adhesive side 13a of substrate 13. By maintaining high particulate loading, the substrate offers virtually limitless bed depth. The solid materials can be used alone or as mixtures. A series of spirals, each containing a different material, can be used as a stack to provide enhanced performance. The low pressure drop of the spiral construction is especially advantageous when multiple spirals are stacked together. In an example, the current invention is used as an adsorber of vaporous contaminants. It can also be used for neutralization of corrosive vapors in a gas stream or as a catalyst support which can either promote gas phase reactions or the catalytic destruction of vaporous contaminants in a gas stream.

In an example of an embodiment, the current invention employs activated carbon adsorbent. Any type of activated carbon product, including impregnated products, can be used with this invention. A preferred product is BLP activated carbon from Calgon Carbon Corporation. Activated carbons ranging in size from U.S. mesh 4×10 to 20×45 have been successfully used with comparable results. Fibrous substrates require specific mesh materials to be used because the larger particles can sit on top of the mat and small particles can fall completely through the mat. In an example, substrate 13 is fully loaded with carbon 14 by saturating adhesive side 13a in bed of carbon and manually applying pressure to the non-adhesive side 13b of substrate 13 to adhere as much carbon to the adhesive 15 as possible. Alternatively, appropriate equipment is used to accurately dispense metered amounts of carbon onto the adhesive.

In preferred embodiments, the composite tape is rolled into a spiral disc or cylindrical form so it can be enclosed in a disc, a cylinder, or any other type of air-permeable housing that will accept the composite spiral. For example, the spiral composite can be build into a rectangular frame for use in rectangular duct work that could be found in homes or in commercial buildings. By this means, a home can be deodorized or a commercial building could be protected from any number of vaporous nuisance materials or toxins. This same means can be used to help remove solvents from an industrial work place to maintain work place safety standards and environmental emissions standards. In another example, the spiral composite is also useful in a device such as a gas mask where low pressure drop is desirable. The compact nature of this novel composite makes it amenable to various application that may not necessarily be effectively addressed by traditional adsorbent devices.

The current invention is also well suited for static applications such as a refrigerator deodorizer. In an embodiment, the composite is rolled into a spiral form so it can be enclosed in a housing that is attractive to the consumer eye, space efficient, and practical for consumer use. The housing is made from readily available thermoplastic materials. It is designed with openings that allow the odiferous air to come in contact with the activated carbon. The housing is made with a simple clam-shell design for easy assembly. In an example, the housing unit includes a disc that is about 1 inch wide and 3.5 inches in diameter. Because of the long-time performance of the device and the low cost, the device is completely disposable. The consumer does not have to purchase and store replacement cartridges. It could also be used, for example, to adsorb odors in other closed spaces such as closets, lockers, gym bags, shoes, tackle box, garbage cans, etc.

Gas streams that can be treated include: ambient air, industrial gases such as nitrogen, oxygen, and hydrogen, or organic gases such as methane, ethylene, acetylene, etc. Standard activated carbon products can be used for many of these applications. A long list of impregnated activated carbon products has been developed over the years to meet the special requirements of specific applications. All of these materials can be used with the current invention. The current invention can also be used in combination with other purification materials, either individually or as mixtures. Combination with a fibrous filter material creates a unit that would not only remove vapors but would also remove particulates from ambient air or any other gas stream. Combination with a water adsorbing zeolite creates a unit that would remove not only vapors but would also dehumidify ambient air or any other gas stream. For example, a series of three composites are stacked consecutively or alternatively with space between them, each having a different adsorbent, such as carbon, zeolite and silica gel. One or more of the composites may have different thicknesses to provide capacities geared to the use of that adsorbent in the desired application.

These examples are not meant to limit the uses of the present invention. The dimensions of the substrate and shaped composite are anticipated to vary greatly depending upon the desired use and particular application. Those skilled in the art will appreciate the variances and realize the utility and wide range of uses for such a novel adsorbent material used alone or in combination with particulate filters or other adsorbent materials.

### EXAMPLE 1

A spiral adsorbent composite was created by pressing the adhesive side of a strip of ½″ SCOTCH® Magic™ Tape 810 into a tray of granular carbon and completely coating the adhesive with the carbon. The substrate tape measured 113 linear inches. The carbon was a U.S. 20×45 mesh BLP granular activated carbon from Calgon Carbon Corporation having an apparent density of 0.540 g/cc. The coated composite was wound into a tight spiral measuring about 3.5 inches in diameter. The spiral was enclosed in an air permeable, disc-shaped prototype housing 18 as shown for example in FIG. 6. Housing 18 has air permeable face 19. Tests were conducted on this prototype unit. The carbon density of the spiral composite was 0.181 g/cc. This density was selected to optimize a balance between increasing access to the carbon while maintaining a high volumetric carbon density. As a result faster adsorption kinetics were obtained while maintaining a high adsorption capacity for the spiral composite unit.

A butane activity test was carried out to determine the capacity of both the loose, bulk carbon and the spiral adsorbent composite by evaluating the grams of butane adsorbed per 100 grams of carbon. For this test, each item was in placed in contact with a stream of butane gas. The test was conducted on a prototype unit that was a disc that was 0.5″ wide and 3.5″ in diameter. Two petrie dish bottoms with most of the face cut out were used. The hole was covered with a plastic mesh screen and the spiral was inside. The plastic mesh screen simulated the air flow perforations that will be molded into the housing. After exposing them to test, the items were weighed after 20 and 40 minutes of exposure (although in most cases the carbon is already saturated after a 20 minute exposure). The butane activity of the bulk carbon was 24.04 g butane/100 g carbon. The butane activity of the carbon in the spiral adsorbent composite was 22.30 g butane/100 g carbon. The capacity loss would be much greater in a system where the carbon was coated with an adhesive and then applied to the substrate because the liquid adhesive plugs a large percentage of the pores in the carbon.. The actual butane activity of the spiral adsorbent composite was 4.18 g butane adsorbed/spiral unit.

The kinetic performance of the spiral adsorbent composite was also measured. This test shows how quickly odors will be adsorbed by a given adsorbent or a given odor adsorbing device. This test was a modification of the butane adsorption test where the weight gain due to adsorption of the butane was monitored with time and not just measured at the final saturation level. The spiral adsorbent composite adsorbed 2.3 grams of butane in 30 minutes.

Unlike traditional adsorbers or deodorizer units that use loose, bulk granular carbon, the adsorbent composite and results of these tests showed the granules do not grind against each other during use. Thus, with the current invention, dusting is decreased as a result of the immobilization of the carbon granules.

### COMPARATIVE EXAMPLE 1

A commercially available refrigerator deodorizer was tested for comparison purposes. The deodorizer contained carbon in the form of a hollow extruded cylinder of “Activated Charcoal”. The deodorizer was subjected to a butane activity test, as described in Example 1. The test revealed the butane activity of the activated charcoal inside the deodorizer was 3.7 g butane/100 g activated charcoal. This compares to a butane activity of 22.3 g butane/100 g activated carbon attached to the substrate with the current adsorbent composite invention; a 6 fold increase in the capacity of the carbon to adsorb odors. The butane activity of the full commercial deodorizer unit was 0.30 g butane/unit. This compares to a butane activity of 4.18 g butane/unit with the current invention; a 14 fold increase in the capacity of the unit to adsorb odors. These results illustrate how the unique construction of the current invention results in a much higher carbon capacity and a much higher unit capacity. This, in turn, results in a more efficient deodorizer device with a significantly longer service life.

### COMPARATIVE EXAMPLE 2

In this example, the kinetic test was performed as described in Example 1. Again, this test shows how quickly odors will be adsorbed by a given adsorbent or a given odor adsorbing device. The same type of carbon and the same amount of carbon that was contained in the spiral composite were used for the test. An open pile of loose, bulk carbon was used for the test. In 30 minutes, the loose carbon had only adsorbed 1.7 grams of butane while the carbon spiral had adsorbed 2.3 grams of butane in the same period of time. That represents a 35% increase in the rate of butane adsorption because of the enhanced access to the carbon granules. If a deodorizer is slow to adsorb the odors in a refrigerator, they could be adsorbed by other foods or ice cubes before they are captured by the deodorizer. These results clearly demonstrate the improved kinetics of the current invention and therefore, the improved efficiency as a vapor adsorption device for static or forced air applications. This is especially true for refrigerators and freezers since they do have intermittent air circulation.

### COMPARATIVE EXAMPLE 3

The pressure drop with a fixed amount of carbon was measured in two forms: the carbon spiral form and a packed bed of bulk carbon. As previously mentioned, the unique spiral construction of the present invention spreads out the carbon granules and immobilizes them in space. The bulk carbon had a bed depth of 1.7 cm while the spiral spread the same amount of carbon out to a bed depth of 3.0 cm. This test demonstrated that a result of spreading the carbon bed out provided a significant reduction in the pressure drop of the bed. The test was conducted using 80 ppm butane in an air stream at 50% relative humidity and 0.6 m/sec linear velocity. The pressure drop of the packed bed of carbon was 0.095 inches of water while the pressure drop with the spiral construction bed was 1.010 inches of water. This represents a 10 fold decrease in the pressure drop which is desirable for many applications. The lower pressure drop is desirable because forced air filtration systems can be designed with smaller, cheaper blowers which consume less energy. This reduces the cost of a filtration unit, the space required, and the operating costs. For other applications that are already designed to handle higher pressure drops, the spiral design allows for the use of higher flow rates, and therefore higher treatment rates. This results in more efficient equipment utilization and therefore lower operating costs.

While the present invention has been described in conjunction with several embodiments thereof, many modifications and variations will be apparent to those of ordinary skill in the art. The foregoing description and the following claims are not intended to cover all such modifications and variations.

1. A composite adsorbent for treatment or adsorption of gases comprised of a shaped substrate having an adhesive on a portion of at least one side thereof, and an adsorbent that has been immobilized as a layer on said adhesive portion of said substrate.

2. A composite adsorbent as set forth in claim 1 wherein said adsorbent is selected from the group consisting of activated carbon, impregnated activated carbons, silicas, natural and man-made zeolites, molecular sieves, clays, aluminas, or ion exchange resins.

3. A composite adsorbent as set forth in claim 2 wherein said activated carbon is granular activated carbon.

4. A composite adsorbent as set forth in claim 1 wherein said substrate is a pressure sensitive adhesive tape.

5. A composite adsorbent as set forth in claim 1 wherein said substrate is selected from the group consisting of acrylics, polycarbonates, polyimides, polyphenylene ether, polyphenylene sulfide, acrylonitrile-butadiene-styrene copolymers, polyesters, ethylene vinyl acetate, polyurethanes, polyamides, polyolefins, blends and derivatives thereof.

6. A composite adsorbent as set forth in claim 1 wherein said shaped substrate is in the shape of a spiral, disc, cylinder or otherwise folded so that said adsorbent contacts a side of said substrate that does not contain adsorbent.

7. A composite adsorbent as set forth in claim 1 in combination with an air permeable housing.

8. A composite adsorbent as set forth in claim 7 wherein said housing includes an impermeable unit having a screen, holes, open lattice structure, or permeable fabric portion.

9. A method for making a shaped composite adsorbent for treatment or adsorption of gases in an application comprising:
a. sizing a substrate for said application having an adhesive on a portion of at least one side thereof;
b. coating said substrate adhesive portion with adsorbent;
c. folding said coated portion so that said adsorbent contacts a side of said substrate that does not contain adsorbent.

10. A method for making a composite adsorbent as set forth in claim 9 wherein said folding results with said substrate being folded into the shape of a spiral, disc, cone or cylinder.

11. A method for making a composite adsorbent as set forth in claim 9 wherein said coating substantially coats said substrate adhesive portion with adsorbent to provide a high particulate loading of said adsorbent.

12. A method for making a composite adsorbent as set forth in claim 9 wherein said coating applies a mono-layer of adhesive onto said adsorbent.

13. A method for making a composite adsorbent as set forth in claim 9 wherein said including one further step of combining said composite adsorbent with one or more of said composite adsorbents.

14. A composite adsorbent as set forth in claim 1 wherein said adhesive is selected from the group consisting of acrylics, vinyl ethers, natural or synthetic rubber-based materials, poly (alpha-olefins), and silicones.

15. A composite adsorbent as set forth in claim 1 wherein said adhesive is an integral part of a portion of said substrate.

16. A composite adsorbent as set forth in claim 1 wherein said shaped substrate is used as a folded sheet, layers of sheets, ribbon, roll, coil, or disk.

17. A composite adsorbent as set forth in claim 1 wherein said substrate is used combined with one or more additional of said substrates.
